(19) United States
(12) Patent Application Publication
(10) Pub. No.: US 2015/0083714 A1
(43) Pub. Date: Mar. 26, 2015

(54) WIDE BAND CHOKE DESIGN FOR SUPPRESSING ELECTROMAGNETIC LEAKAGE IN MICROWAVE OVENS

(71) Applicant: TUBITAK, Ankara (TR)

(72) Inventors: Bahattin Turetken, Kocaeli (TR); Erkul Basaran, Kocaeli (TR); Koray Surmeli, Kocaeli (TR)

(21) Appl. No.: 14/388,767

(22) PCT Filed: Mar. 27, 2013
(86) PCT No.: PCT/IB2013/052456

§ 371 Date: Sep. 26, 2014

(30) Foreign Application Priority Data
Mar. 28, 2012 (TR) 2012-03550

(51) Int. Cl. H05B 6/76

(52) U.S. Cl. CPC H05B 6/763
USPC 219/740; 219/742

(57) ABSTRACT

A microwave oven that consist of a cooking chamber, a door for opening and closing the chamber, the E-type choke structure that filter the electromagnetic leakage is placed inside the door frame and a transparent glass surface covering this structure. The E-type choke on the door has two parallel cavities, a periodic prism array that seperate the cavities and periodic slots on the outer side walls of the cavities. The new E-type choke structure produce two resonance frequencies that one of them is greater and the other one is smaller than the center frequency of the microwave oven. Thus, electromagnetic leakage can be filtered over a wide frequency range.

### FIELD OF THE INVENTION

The present invention relates to electromagnetic compatability. This invention is related with microwave ovens and development of electromagnetic leakage supressing capabilities of these microwave cookers. A choke structure with wide coverage frequency range has been formed for decreasing leakage which occurs from the gap in microwave oven doors. This leakage is necessary to decrease for health and electro-magnetic compatability issues.

### BACKGROUND OF THE INVENTION

Microwave ovens are electronical devices that has a high power magnetron to cook food which are placed inside the oven. Microwave ovens consist of a cooking chamber and a door system placed to open and close this chamber.

In the microwave ovens a certain gap occurs between the oven and its door because of the production accuracy. An electromagnetic leakege propagate to the exterior medium because of the gap. The leakage suppression is an important subject since the leakage is very harmful for both electronical devices and also human health.

To suppress these electromagnetic leakage several methods are developed by using electromagnetically leakproof structures such as ferrit rubber, capacitive sealing and choke.

The first used seal structure was pressure latch system to reduce the leakage arised from the microwave oven door. However another methods have been developed since these latches have usage diffuculty and low shielding effectiveness. Instead of the latching system, the choke structures that keep the electromagnetic leakage inside the cooking chamber was placed on the door frame and these structures have been patented. As the physical dimensions and shielding effectiveness of the choke structures developed, these inventions conserved by new patents. However many of these structures have narrow frequency band and can filter f_{c} operating frequency as shown in FIG. 1. Filtering degree of electromagnetic leakage in dB is shown in FIG. 1 when the microwave oven door is closed.

The frequency of leakage field can shift over or under the operating frequency f_{c} since the foods are frequency dispersive materials. In addition to this, the operating frequency f_{c} can shift since the signal source that feeds the fields inside the oven can not close instantly while the door is opening. Besides this shifting effect, the magnetron which the signal source of the microwave oven can not operate in the pure f_{c} center frequency and has a certain frequency bandwidth. Another effect that increases the bandwidth is the electrical pulse effect occur during on/off process magnetron source.

Therefore the choke structures developed to suppress leakage must cover the bandwidth occured by frequency shifting and broadening. To achieve this, the choke structure should be designed for wide bandwidth rather than narrow bandwidth as in FIG. 1.

The related patents about the subject are as in the following.

U.S. Pat. No. 4,700,034, U.S. Pat. No. 7,402,784, U.S. Pat. No. 6,538,241, U.S. Pat. No. 4,659,891, U.S. Pat. No. 5,036,171, U.S. Pat. No. 5,418,352, US20030141298, US20050067412.

One can find further information about choke structures' historical development and their theoretical bases in ‘Elektromanyetik I [symbol] mayi Önleyen Ergonomik Kapak Tasarimina Yönelik Analizler’ [E. Basaran, K. Surmeli, B. Turetken; Elektromanyetik I [symbol] imayi Önelik Ergonomik Kapak Tasarimina Yönelik Analizler, 1. Ulusal EMC Konferansi, Ekim 2011, Istanbul.].

### OBJECT OF THE INVENTION

The main goal of the present invention is to develope the suppression capacity of the electromagnetic leakage originated from the microwave oven door and to provide it to be cleaned easily by widening the glass surface on the oven side of the door.

To achieve this aims, a microwave oven 1 that consist of a cooking chamber 2, a magnetron source feeding this chamber, a door 3 to open and close the chamber is designed withnew E-type choke structure. The E-type choke on the door has two parallel cavities 7, 8, a periodic rectangular prism array that separates the cavities 9 and periodic slots 10 on the outer side walls of the cavities. The new E-type choke structure produce two resonance frequencies that one of them is greater and the other one is smaller than the center frequency of the microwave oven.

The E-type choke structure operates in wider frequency bandwidths thanks to these two resonance frequencies. Thus, this wide frequency bandwith structure can filter frequency shifting and broadening effects such as dispersive foods, bandwith of RF signal of the source, on/off process of the source and the source system turn off deficiency that arises while the door is opening.

Presented new door system enables to design wider window surface thus the oven can be easily cleaned. In addition to this, E-type choke can filter electromagnetic leakage within wide frequency range.

Presented microvave oven's door has two distirict cavity areas which are between periodically sloted walls. These cavity areas are seperated with a prism array.

Periodically traveling slot structures take part of the inner sides of the side wall. These used slot structures and prism array between the slot structures provide two resonance frequencies. Thus filtering bandwith against electromagnetic leakega of the oven increases. These slot and cavity structures are explained detailed with figures in the following sections.

### BRIEF DESCRIPTION OF THE DRAWINGS

The figures and graphs related to E-type choke structure is given below. The microwave oven expressed in ‘Size reduction of the Door Seal Structure of a microwave Oven by the FD-TD Method’ [Kusama, Y.; Hashimoto, O.; Makida, M.; ‘Size Reduction of the Door Seal Structure of a Microwave Oven by the FD-TD Method,’ Electronics and Communications in Japan, Part2. Vol.86, No.10, pp 73-83, 2003. 1] is named conventional microwave oven in the sections.

In the drawings;

FIG. 1 is a graph showing filtering characteristic of electromagnetic leakage of the conventional microwave oven.

FIG. 2 is a drawing showing perspective view of the microwave oven according to present invention.

FIG. 3 is a drawing showing the cross section of the microwave oven in FIG. 2.

FIG. 4 is a drawing showing perspective view of the door consists of E-type choke structure with cavities and prisms.

FIG. 5 is a graph showing filtering efficiency against electromagnetic leakage and bandwidth of the E-type choke structure.

### DETAILED DESCRIPTION OF THE INVENTION

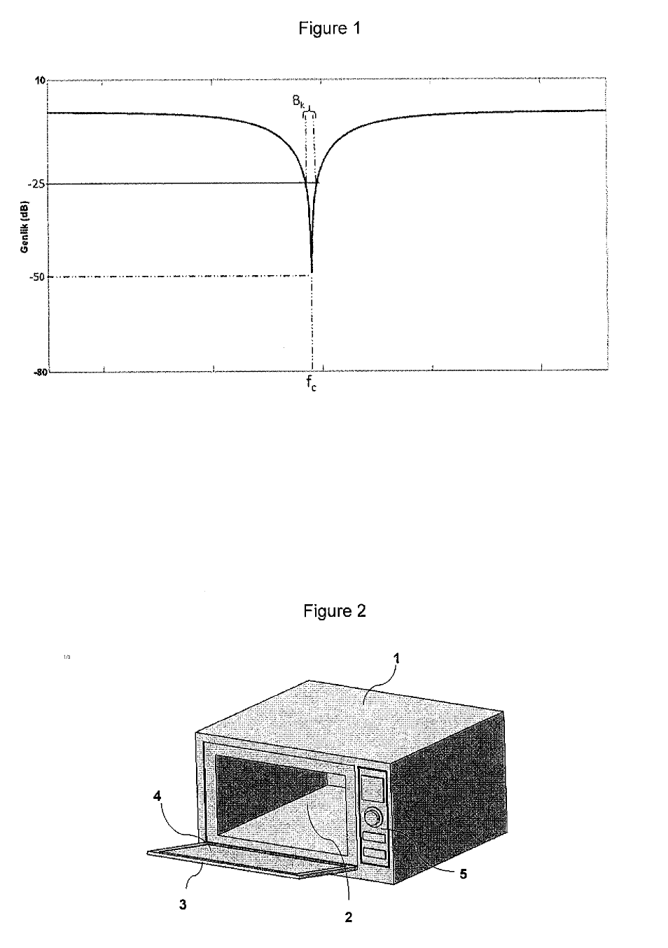

FIG. 1 shows electomagnetic leakage value against frequency in dB belonging to conventional microwave oven while the door is closed. The minimum value of the curve is resonance frequency of the filtering structure. Minimum value of the electromagnetic leakage and maximum filtering is in the operating frequency f_{c} of the microwave oven. The frequency of the leakage signal can shift below or above the f_{c} frequency. These effects are related to frequency dispersive properties of the foods, lack of sudden turn off abilility of the source, the frequency bandwidth of the magnetron, electrical pulse effect during the on/off process. Absolutely, the filtering capability is insufficient in these situations since the conventional structures have narrow bandwidths. The bandwidth of the conventional choke is shown as Bₖ in FIG. 1.

FIG. 2 shows a microwave oven used in the present invention. Microwave oven comprises a body 1, a cooking chamber 2 that foods are placed inside it, a door 3 to open and close the cooking chamber, a window 4 that has an ability to show inside the cooking chamber is placed on the door and a control panel 5.

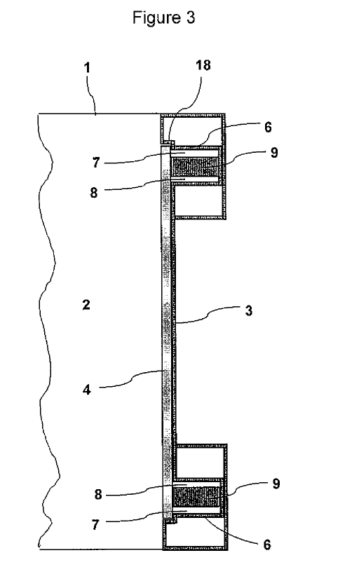

FIG. 3 shows cross section view of the microwave oven. The E-type choke structure 6 that filters the electromagnetic leakage is placed inside the door frame. This structure consists of two parallel cavities 7, 8, a rectangular prism array 9 that separate these two cavities and periodic slots 10 on the inner sides of the side walls 11.

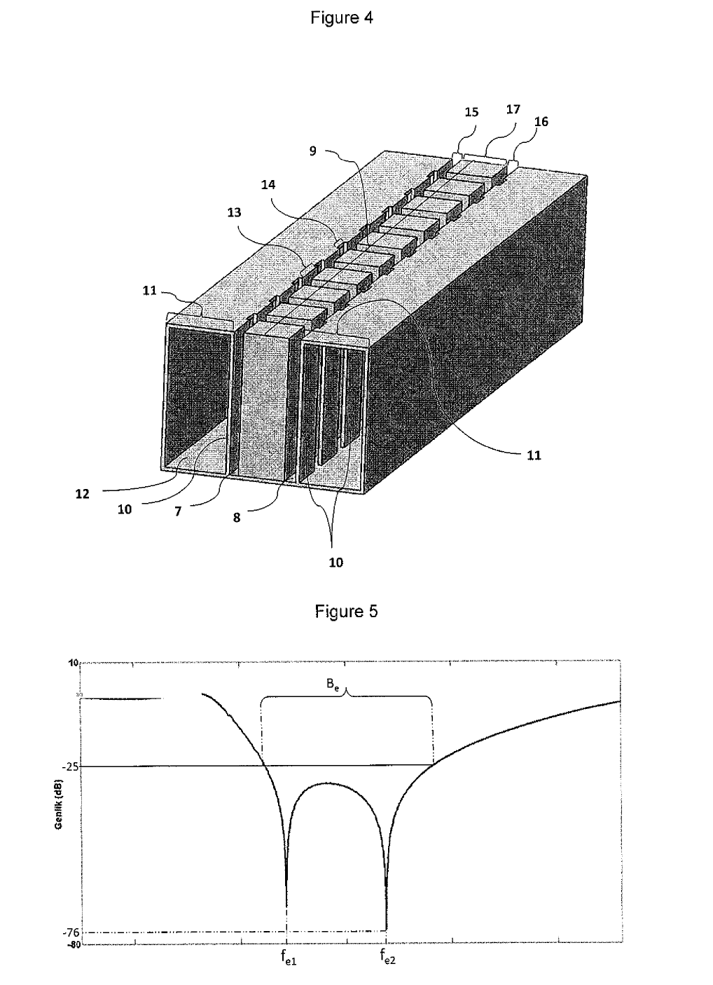

FIG. 4 shows the E-type choke structure on the door frame that is presented by the invention. This E type choke structure consists of two cavity area 7, 8, a prism array 9 that separate these two cavities and periodic slots 10 on the inner sides of the side walls 11. Cavities 7, 8 and prism array 9 that separate these cavities are constracted on the same floor 12. Prism array 9 can be assembled to the floor 12 by using solder. The slots and the prisms are lined up periodically to suppress higher order leakage signals. Resonance frequency values are determined by physical sizes such as slot length 13, slot intervals 14, cavity width 15,16 and prism width 17. One can change the resonance frequencies by modifying these sizes.

A sample calculation is made in the present invention. According to this, for a 150 mm lenght E type choke structure that operates at around 2.45 GHz (f_{c}) after some optimization the obtained results are; the lenghts of the slots that inside the side walls are 10.5 mm, distance between slots is 5 mm, widths of the cavities according to leakage traveling direction are 6 mm and 5 mm respectively, prisms array's width that separate the cavities is 10 mm and the depth of the E-type choke structure is 31.2 mm. E-type choke structure's resonance frequencies for these values are obtained as 2.20 GHz (fₑ₁) and 2.70 GHz (fₑ₂).

FIG. 5 shows leakage amplitude against frequency for E-type choke design when the door is closed. This new structure has two resonance frequencies named as fₑ₁ and fₑ₂ in FIG. 5. In other words, there are two critical frequency values for which the leakage is minimum and the filtering is maximum. The filtering effect is also high between these critical frequencies. The E-type choke obviously overcomes above mentioned frequency shifting effects since it has a wideband filtering capability. That is, the frequency variations are in the interval of frequency bandwidth of the E-type choke. The frequency bandwith of E-type choke is expressed as Bₑ in FIG. 5 which is approximately 27 times greater than Bₖ. Furthermore, the filtering capability of the E-type choke structure is 26 dB better than the classical structure at resonance frequency.

### THE APPLICATION OF THE INVENTION TO THE INDUSTRY

The presented E-type structure does not cause any changes in the oven chamber. Therefore microwave oven's chest can be manufactured by the same manner. The door frame of the oven has an E-type chock structure that consists of two parallel cavities, a prisim array that seperates these cavities and periodic slots that are inside the side wall of the cavities. These periodic array and slots can be assembled to the floor by using solder. A transparant glass surface is placed on the E-type choke structure. This glass surface can be extended to the step 18 that is close to the oven's outside. Thus the glass surface faced the oven can be extended and the oven can be cleaned easily.

1. A microwave oven comprising
a body having a cooking chamber (2) having one opened side,
a door (3) for opening and closing the cooking chamber,
a transparant window surface with metal grate (4) placed on the door frame and has an ability to show inside the cooking chamber.
Characterized in that it has
an E-type choke structure (6) comprising,
two cavities (7, 8) seperated by the prsim array (9) and,
periodic slots (10) on the inner sides of the side walls (11)
that placed on the door frame of the oven and can filter electromagnetic leakage.

2. The E-type choke stucture according to claim 1 wherein the slots (10) and the prisims (9) are lined up periodically through the door frame to suppress higher order leakage signals.

3. The E-type choke stucture according to claim 1, wherein cavities and prism array that separates these cavities are constracted on the same floor (12).

4. The microwave oven according to claim 1, wherein the metal grated transparent glass surface placed on the door is extended over the E-type choke and reclined to the step (18).

5. The microwave oven according to claim 1, wherein the door surface viewing the oven body is purified by removing plastic-like materials and the transparent glass extended to the place of the plastic material.

6. The microwave oven of claim 1, wherein the door structure is produced without the use of carbon and ferrite types materials

7. E-type choke stucture for microwave ovens characterized in that it filters,
Operating frequency f_{c}
Frequency compenents around the operating frequency fc due to frequency bandwith of magnetron source.
Frequency compenents around the operating frequency fc due to electrical pulse effect of on/off process.
Frequency shifting due to the dispersive foods inside the oven

8. The E-type choke stucture according to claim 1 wherein the filtering effect is better than 30 dB between fₑ₁ and fₑ₂ where the maximum filtering is occured.
